(19) United States
(12) Patent Application Publication
(10) Pub. No.: US 2020/0337504 A1
(43) Pub. Date: Oct. 29, 2020

(54) Portable Bathing Tub

(71) Applicant: Jon Swiney, Ralph, AL (US)

(72) Inventor: Jon Swiney, Ralph, AL (US)

(21) Appl. No.: 16/840,901

(22) Filed: Apr. 6, 2020

Related U.S. Application Data
(60) Provisional application No. 62/839,011, filed on Apr. 26, 2019.

(51) Int. Cl. A47K 3/022; A47K 3/00; A47K 3/12; A47K 4/00

(52) U.S. Cl. CPC A47K 3/022; A47K 3/001; A61G 7/0005; A47K 4/00; A61G 2200/32; A47K 3/125

(57) ABSTRACT

A portable bathing tub is shown and described. The portable bathing tub includes a frame having a housing placed on frame. The frame has a plurality of casters located on a bottom side of the frame. The housing is made up of a plurality of sidewalls and a top portion. The top portion includes a tub portion and a sink portion. There is a retractable shower fluidly connected to a water inlet source. There is further a grey water tank location within the housing supported by the frame.

### CROSS REFERENCE TO RELATED APPLICATIONS

This application claims the benefit of U.S. Provisional Application No. 62/839,011 filed on Apr. 26, 2019. The above identified patent application is herein incorporated by reference in its entirety to provide continuity of disclosure.

### BACKGROUND OF THE INVENTION

The present invention relates to a portable bathing tub. More particularly, the present invention provides a portable bathing tub that can aid in bathing bedridden medical patients or elderly individuals.

Bathing of bedbound, incontinent patients creates a serious problem in the day to day of the individuals living in this condition. The current system of bathing these individuals is with a process known as the bed bath. To begin this outdated procedure, the staff will first gather the multitude of washcloths and towels that will be required. Then a small wash basin is filled with warm, soapy water. The staff will make multiple trips to the nearest washroom to rinse and refill the basin throughout the process. It's practically inevitable that some spillage or splashing upon emptying will occur during the process of transporting these soiled basins to the washroom.

To further complicate matters, the soiled bed linens must be changed during the process. Accomplishing this with the patient in the bed, and without soiling the clean linens is a very difficult task. During the procedure, bacteria and other potentially infectious materials are often spread to other surfaces in the facility. Furthermore, these infectious materials can easily be transmitted to staff clothing or shoes facilitating transfer even outside the facility. This process has many shortcomings the first of which is the physical improbability that a patient is properly cleaned and placed back in a completely cleaned bed.

This physical improbability often leads to Incontinence-Associated Dermatitis (IAD). IAD is a skin inflammation associated with exposure to urine and/or stool. This condition begins with slight redness, and if not well managed it will rapidly progress in severity until varying degrees of skin breakdown are experienced. This loss of skin integrity, besides being very painful, often leads to severe infection as it is occurring in a naturally bacteria-laden area of the body.

In most medical texts, the prevention/treatment of IAD focuses on two fundamentals.

1) Avoid/minimize exposure to urine and stool; and

2) combine that with a skin-care program of gentle cleansing followed by the application of various moisturizers, emollients, and skin protectants.

The second part of those instructions which involves, “gentle cleansing” can be extremely difficult. With no means of safely placing these patients into an existing bathtub or shower, the only current alternative comes in the form of a bed bath which is grossly ineffective and creates multiple hazards for both patients and staff.

As anyone can imagine, this is a very daunting and difficult task for the staff. For the patients, however, it's much worse. The procedure is often excruciatingly painful due to the presence of IAD. Under these circumstances, and without being able to submerse the perineal and sacral areas in water, a great deal of scrubbing is often necessary to sufficiently cleanse the area. This scrubbing of an already inflamed area often results in a large amount of pain. The staff is faced with the decision of continuing until thoroughly clean or mercifully stopping the torture. It's a very difficult situation/decision as the skin inflammation will only worsen if not adequately cleansed.

Consequently, there is a need in for an improvement in the art of bathing bedridden individuals. The present invention substantially diverges in design elements from the known art while at the same time solves a problem many people face when bathing bed ridden individuals. In this regard the present invention substantially fulfills these needs.

### SUMMARY OF THE INVENTION

The present invention provides a portable bathing tub wherein the same can be utilized for providing convenience for the user when using a portable bathing tub. The portable bathing tub is comprised of a frame with a housing placed therearound. The frame has a plurality of casters located on the bottom thereof. The housing has a plurality of sidewalls and a top portion. The top portion is configured to have a bathtub therein. The top portion is further configured to have a sink placed adjacent to the bathtub.

Another object of the portable bathing tub is to have a grey water tank located within the housing, wherein the gray water tank is fluidly connected to a bathtub drain.

Another object of the portable bathing tub is to have at least one drive motor, wherein the at least one drive motor is attached to at least one of the casters.

Another object of the portable bathing tub is to have floor trucks located adjacent to at least two casters, wherein the floor trucks will raise the casters from a floor surface.

Another object of the portable bathing tub is to have a water heater. The water heater is fluidly connected to a water intake line. A thermostat is operably connected to the water heater to set a desired water temperature.

Another object of the portable bathing tub is to have a retractable showerhead, wherein the showerhead is fluidly coupled to a water intake line.

Another object of the portable bathing tub is to have water supply hose, wherein the water supply hose is configured to connect to a water supply bringing water to the bathing tub.

Another object of the portable bathing tub is to have the sink have a horseshoe cut away in the side adjacent to the tub for a user to place their head neck area therein.

Another object of the portable bathing tub is to have a heating element wherein the heating element is a heated air system.

Another object of the portable bathing tub is to have a heating element wherein the heating element is a heated cable system.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the portable bathing tub.

FIG. 2 shows a perspective view of an embodiment of the portable bathing tub.

FIG. 3 shows a right side cross-sectional view of an embodiment of the portable bathing tub.

FIG. 4 shows a left side cross-sectional view of an embodiment of the portable bathing tub.

FIG. 5 shows a rear view of an embodiment of the portable bathing tub.

FIG. 6 shows a diagram of an embodiment of the wiring for the portable bathing tub.

FIG. 7 shows a diagram of an embodiment of the plumbing for the portable bathing tub.

### DETAILED DESCRIPTION OF THE INVENTION

Reference is made herein to the attached drawings. Like reference numerals are used throughout the drawings to depict like or similar elements of the portable bathing tub. For the purposes of presenting a brief and clear description of the present invention, a preferred embodiment will be discussed as used for the portable bathing tub. The figures are intended for representative purposes only and should not be considered to be limiting in any respect.

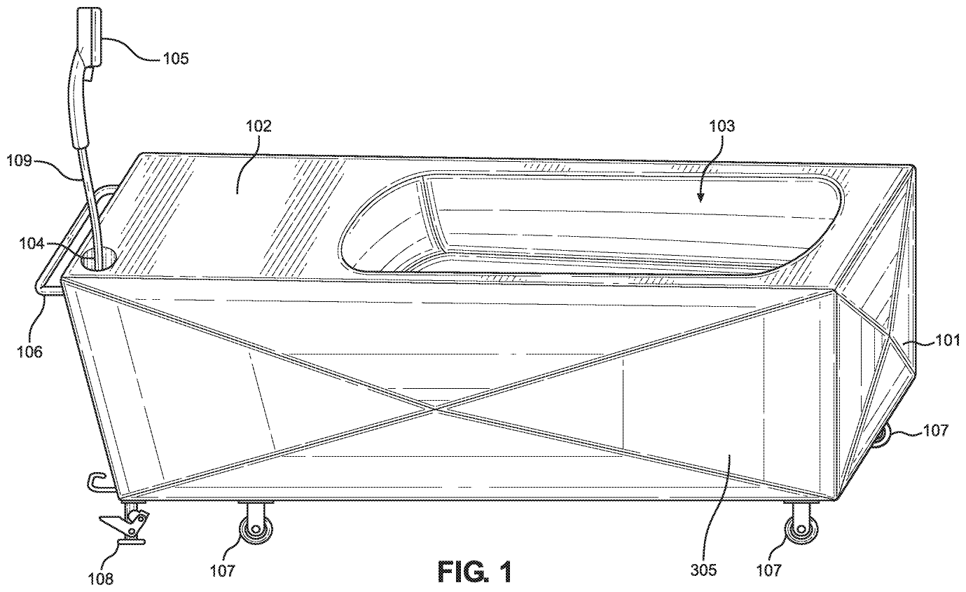

Referring now to FIG. 1, there is shown a perspective view of an embodiment of the portable bathing tub. The portable bathtub includes a housing. The housing is comprised of a plurality of sidewalls 101 and a top section 102. In the shown embodiment the top section 102 has a tub portion 103. The tub portion 103 is depressed into the top section 102. In the shown embodiment the tub portion 103 has a uniform depth. In other embodiments as shown and described throughout there are different dimensions and features to the tub portion 103. The top section 102 has at least one aperture 104 located therein. The aperture 104 allows access to the interior of the housing.

In one embodiment a showerhead 105 is fluidly connected through the aperture 104. The showerhead 105 is fluidly connected to a water hose 109. The water hose 109 is then fluidly connected to a water source as described below. In one embodiment the aperture 104 is proportioned to allow the showerhead 105 to fit fully within the interior volume of the portable bathing tub. This will prevent the showerhead 105 from getting caught and potentially broken during transport.

In one embodiment a handle 106 is attached to one of the sidewalls 101. The handle 106 will allow a user to have an item to grasp when moving the portable tub. There is further a plurality of casters 107 attached to the underside of a base of the portable bathtub. The casters 107 are configured to support the weight of a fully loaded portable bathtub. In some embodiments the portable bathtub may weigh over 800 pounds. This can make is extremely difficult to move without the casters and handle. In one embodiment there is at least one floor lock 108 attached to the underside of the base. The floor trucks 108 is configured to be deployed lifting at least the rear casters from the ground holding the portable tub in place.

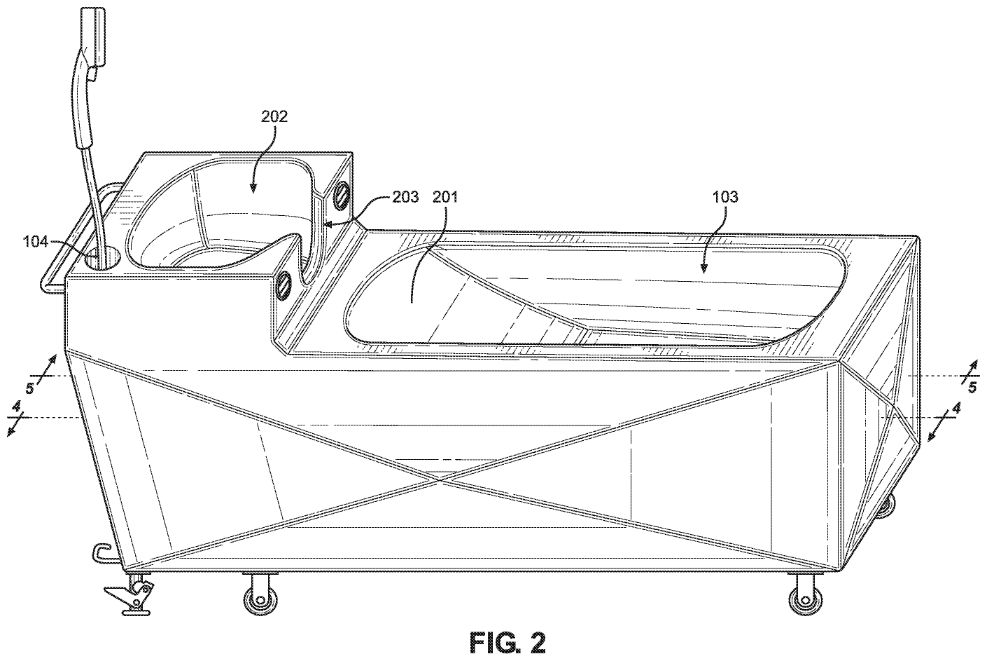

Referring now to FIG. 2, there is shown perspective view of an embodiment of the portable bathing tub. In one embodiment there is further a sink 202 attached to the portable bathing tub. In one embodiment the sink 202 is located above and adjacent to the tub portion 103. In this embodiment the aperture 104 allowing access to the interior is still present. This will ensure that the showerhead 105 is still properly connected and useable.

In one embodiment the sink 202 has a continuous sidewall. In another embodiment the sink 202 has an indent 203 cut into the sidewall. This indent 203 will allow a user to place their head and neck into the sink 202. The indent 203 will allow for comfort and to allow for the head to be located fully within the sink 202. In one embodiment the tub portion 103 has a slanted sidewall portion 201. The slanted sidewall portion 201 will allow a user to better sit in the tub portion 103. Further the slanted sidewall portion 201 will better allow a user to place their head within the sink 202 via the indent 203.

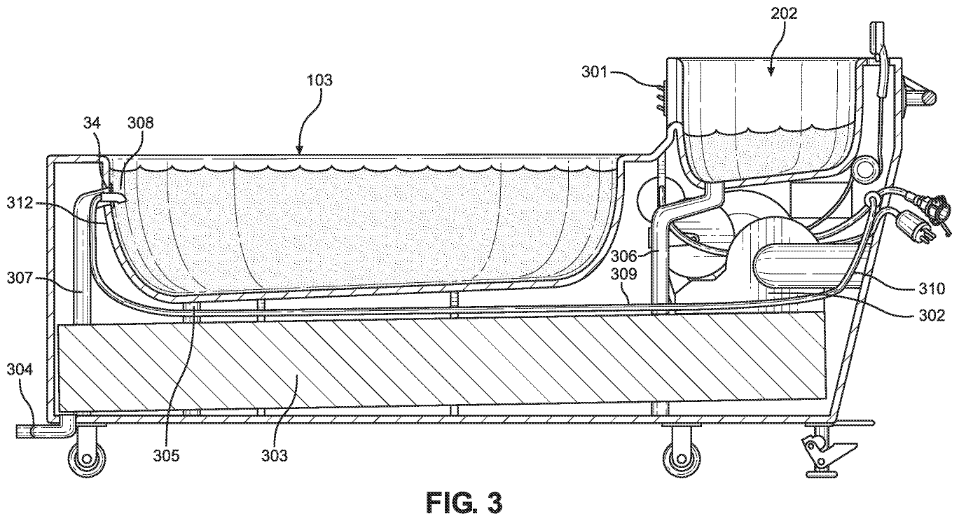

Referring now to FIG. 3, there is shown a cross-sectional view of an embodiment of the portable bathing tub. In one embodiment there is a ventilation system incorporated into the portable bathing tub. In one embodiment there is at least one vent 301 leading from the interior to the exterior of the portable bathing tub. The at least one vent 301 is fluidly connected to a heater element. In this embodiment the at least one vent 301 will dispense warm air onto the user to keep them warm. In the shown embodiment the at least one vent 301 is located beside the indent of the sink. This can also be seen in FIG. 2. The heater element is fluidly connected to an intake pipe 310. The intake pipe 310 will exit the portable bathing tub allowing for fresh air to be circulated through the system and heated.

The portable bathtub further includes a water tank 303. In one embodiment the water tank 303 is capable of holding 80 gallons of water. In a further embodiment the water tank 303 is a brown water tank. In another embodiment the water tank 303 is positioned on an angle relative to the base of the portable bathing tub. This angle of the water tank 303 is positioned such that water will flow toward a drain spout 304. This will ensure that all of the water in the water tank 303 will be drained via the drain spout 304 when the drain spout 304 is opened.

There is further a plurality of drain hoses 305, 306, 307 fluidly connected to the water tank 303. Drain hose 306 is fluidly connected to a drain in the sink 202 and to the water tank 303. This will allow the sink 202 to drain into the water tank 303. Drain hose 305 is fluidly connected from a drain at the base of the tub portion 103 to the water tank 303. This will allow the water from the tub portion 103 to be drained into the water tank 303. Drain hose 307 is an overflow protection hose. The drain hose 307 is fluidly connected from an overflow opening 311 of the tub portion 103 into the water tank 303. This will ensure that excess water is drained from the tub portion 103 into the water tank 303 instead of overflowing.

The portable bathing tub further has a water hose 309 fluidly connected to a water supply at one end as described below. The second end of the water hose 309 is fluidly connected to a waterspout 308. The waterspout 308 is positioned slightly within a sidewall 312 of the tub portion 103. This will ensure that the user does not get caught on the waterspout 308.

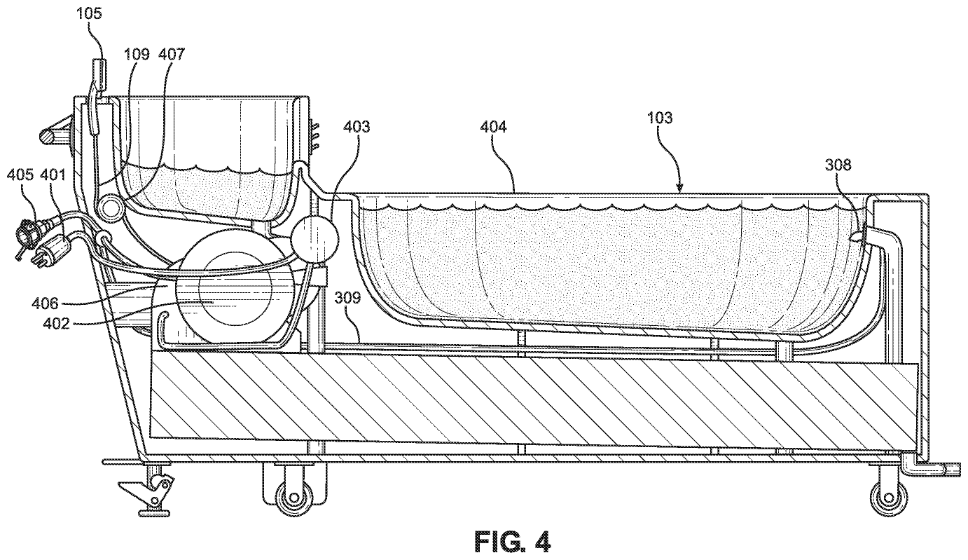

Referring now to FIG. 4, there is shown a cross-sectional view of an embodiment of the portable bathing tub. From this view there is shown a water supply hose 405 ending the portable bathing tub. In one embodiment the water supply hose 405 is coupled to a retractable hose reel 402. In this embodiment the water supply hose 405 can be extended and shortened as needed. In another embodiment a second hose will be needed to lengthen the water supply hose 405.

The water supply hose 405 is fluidly connected to a water heater 406. The water heater 406 will heat water to a desired temperature. The water heater 406 is fluidly connected to the water hose 109 which is fluidly connected to the showerhead 105. In one embodiment the water hose 109 is wrapped around a retractable hose reel 407. In one embodiment the hose reel 407 is biased such that the water hose 109 will automatically retract. This will allow the hose to be neatly kept when the showerhead 105 is returned to the storage position. The water heater 402 is further fluidly connected to the water hose 309 which leads to the waterspout 308.

The portable bathing tub further includes a power supply cord 401. In one embodiment the power supply cord 401 is coupled to a retractable cord reel 403. In this embodiment the power supply cord 401 can be extended and shortened as needed. In another embodiment a second hose will be needed to lengthen the power supply cord 401. In the shown embodiment it can be seen that the power supply cord 401 is electrically coupled to the water heater 402.

In one embodiment the power supply cord 401 is further coupled to a heater wire 404. The heater wire 404 is located around the top edge of the tub portion 103. The heater wire 404 will heat the outer edge of the tub portion 103. This will keep a user warm during a bath.

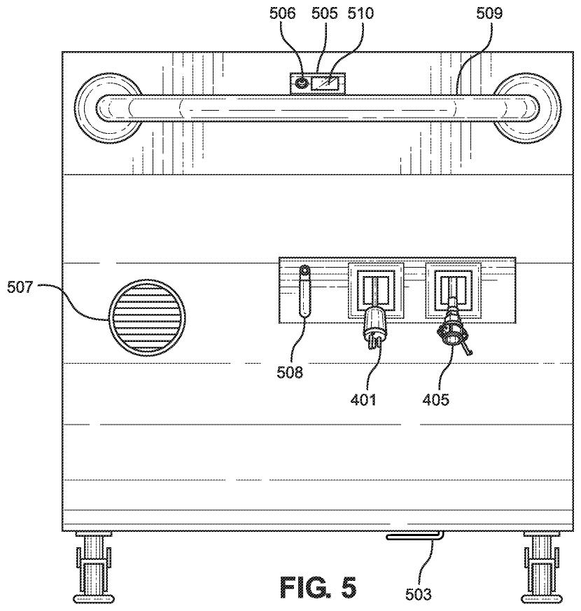

Referring now to FIG. 5, there is shown a rear view of an embodiment of the portable bathing tub. From this angle the power supply cord 401 is seen entering the portable bathing tub. The water supply hose 405 is also shown entering the portable bathing tub. There is shown a hook 503 located at a base of the portable bathing tub. The hook 503 is configured to allow a user to place the power supply cord 401 and the water supply hose 405 therein. This will keep the power supply cord 401 and the water supply hose 405 out of the user's way. The intake vent 507 leading to the heater element is also shown.

A water on/off valve handle 508 is protruded from the portable bathing tub. The water on/off valve handle 508 is connected to a water valve. The water valve when activated will allow for the tub portion to be filled with water.

A pushing handle 106 is attached to the portable bathing tub. The pushing handle 106 is configured to allow a user to push the portable bathing tub. There is further a control panel 505 connected to the pushing handle 106 and the portable bathing tub. The control panel 505 has an electrical on/off switch 506. The electrical on/off switch 506 will activate the water heater and the heating element. The control panel 505 will further display the water temperature and the desired water temperature via a display screen 510. The control panel 505 will allow the user to select a water temperature.

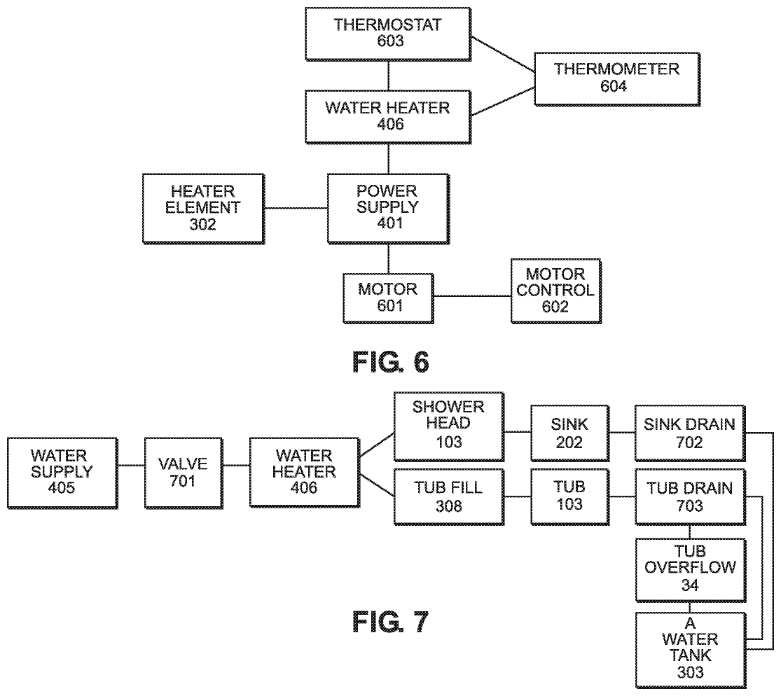

Referring now to FIG. 6, there is shown a diagram of an embodiment of the wiring for the portable bathing tub. There is a power supply 401 connected to the device via the power supply cord. The power supply 401 is then connected to the heater element 302 and the water heater 406. The water heater 406 is connected to a thermostat 603. The thermostat 603 will allow a user to control the water temperature as desired. The water heater 406 and the thermostat 603 are coupled to a thermometer 604. The thermometer 604 will allow a user to view the temperature of the water.

In one embodiment the power supply 401 is connected to a motor 601. The motor 601 is further coupled to a motor control 602. In this embodiment the motor 601 is coupled to at least one caster of the plurality of casters. The motor 601 will be capable of moving the portable bathing tub by propelling the caster.

Referring now to FIG. 7, there is shown a diagram of an embodiment of the plumbing for the portable bathing tub. The water supply 405 is connected to a valve 701. The valve 701 is connected to the water heater 406. The water heater 406 is fluidly connected to the showerhead 103. Once the water leaves the showerhead 103 in one embodiment it flows into the sink 202. From the sink 202 the water will flow into the sink drain 702 and into the water tank 303.

In another embodiment water from the water heater 406 will flow into the tub 308. The water may flow directly into the tub 103 from the tub fill 308. In another embodiment the water flows from the showerhead 105 into the tub 103. From the tub 103 the water flows into the tub drain 703 and to the water tank 303. In another embodiment the water flows through the tub overflow 311 and into the water tank 303.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable bathing tub, the tub comprises:
a frame with a housing placed therearound;
wherein the frame has a plurality of casters located on a bottom thereof;
wherein the housing has a plurality of sidewalls and a top portion;
wherein the top portion is configured to have a tub portion therein.

2) The portable bathing tub of claim 1, further comprising a grey water tank located within the housing, wherein the gray water tank is fluidly connected to a bathtub drain.

3) The portable bathing tub of claim 1, further comprising at least one drive motor, wherein the at least one drive motor is attached to at least one caster of the plurality of casters.

4) The portable bathing tub of claim 1, further comprising floor trucks located adjacent to at least two casters of the plurality of casters, wherein the floor trucks expand and retract to raise the portable bathing tub.

5) The portable bathing tub of claim 1, further comprising a water heater;
wherein the water heater is fluidly connected to a water intake line;
a thermostat is operably connected to the water heater to set a desired water temperature.

6) The portable bathing tub of claim 1, further comprising a retractable showerhead, wherein the showerhead is fluidly coupled to a water intake line.

7) The portable bathing tub of claim 1, further comprising a retractable water supply hose, wherein the water supply hose is configured to connect to a water supply bringing water to the bathing tub.

8) A portable bathing tub, the tub comprises:
a frame with a housing placed therearound;
the frame has a plurality of casters located on a bottom thereof;
the housing has a plurality of sidewalls and a top portion;
the top portion is configured to have a bathtub therein;
the top portion further has a sink portion placed adjacent to the tub portion.

9) The portable bathing tub of claim 8, further comprising a grey water tank located within the housing, wherein the gray water tank is fluidly connected to a bathtub drain.

10) The portable bathing tub of claim 8, further comprising at least one drive motor, wherein the at least one drive motor is attached to at least one caster of the plurality of casters.

11) The portable bathing tub of claim 8, further comprising floor trucks located adjacent to at least two casters of the plurality of casters, wherein the floor trucks expand and retract.

12) The portable bathing tub of claim 8, further comprising a water heater;
wherein the water heater is fluidly connected to a water intake line;
a thermostat is operably connected to the water heater to set a desired water temperature.

13) The portable bathing tub of claim 8, further comprising a retractable showerhead, wherein the showerhead is fluidly coupled to a water intake line

14) The portable bathing tub of claim 8, wherein the sink has a horseshoe cut away in the side adjacent to the tub for a user to place their head neck area therein.

15) A portable bathing tub, the tub comprises:
a frame with a housing placed therearound;
the frame has a plurality of casters located on the bottom thereof;
the housing has a plurality of sidewalls and a top portion;
the top portion is configured to have a bathtub therein;
a heating element is further included to heat the area around a top of the tub portion.

16) The portable bathing tub of claim 15, further comprising a grey water tank located within the housing, wherein the gray water tank is fluidly connected to a bathtub drain.

17) The portable bathing tub of claim 15, further comprising a water heater;
wherein the water heater is fluidly connected to a water intake line;
a thermostat is operably connected to the water heater to set a desired water temperature.

18) The portable bathing tub of claim 15, further comprising a retractable showerhead, wherein the showerhead is fluidly coupled to a water intake line

19) The portable bathing tub of claim 15, wherein the heating element is a heated air system.

20) The portable bathing tub of claim 15, wherein the heating element is a heated cable system
